(19) United States
(12) Patent Application Publication
(10) Pub. No.: US 2011/0174893 A1
(43) Pub. Date: Jul. 21, 2011

(54) DRIP IRRIGATION SYSTEMS AND METHODS

(76) Inventors: Michael A. Allan, Sonora, CA (US); Herve Calleja, Nogueres (FR)

(21) Appl. No.: 12/709,142

(22) Filed: Feb. 19, 2010

Related U.S. Application Data
(60) Provisional application No. 61/296,393, filed on Jan. 19, 2010.

(51) Int. Cl. B05B 15/00

(52) U.S. Cl. 239/8; 239/142

(57) ABSTRACT

Systems and methods for injecting materials into soil within a predetermined geographical area are described. One or more tanks store chemicals and a mixing chamber in an injector mixes measured quantities of the chemicals. The mixture is introduced to a stream of water and thence to the soil. A controller monitors the flow of chemicals and the stream of water and causes the injector to release discrete predetermined amounts of the chemical mixture into the soil at a sequence of injection points. The controller can provide a pulsed signal to control the volume and rate of delivery of water. The controller may operate according to a treatment plan.

### CROSS-REFERENCE TO RELATED APPLICATIONS

The present Application claims priority from U.S. Provisional Patent Application No. 61/296,393 filed Jan. 19, 2010, entitled “Drip Irrigation Systems and Methods,” which is expressly incorporated by reference herein for all purposes.

### BACKGROUND OF THE INVENTION

1. Field of the Invention

The present invention relates generally to systems and methods for delivering chemicals into soil and more particularly relates to systems and methods for delivering substances including fertilizer, fumigants, non-fumigant pesticides, biologicals and other chemicals and combinations of such substances to prepare the soil for planting.

2. Description of Related Art

Devices and systems are currently used for applying substances or chemicals to soil. Such devices distribute a continuous flow of material by spraying it over a targeted area or onto the soil. Concomitantly, there is a large amount of the material applied to the target area in order to achieve a minimum degree of treatment. There is a need for a more efficient and accurate distribution of chemicals into and onto the target soil area.

### BRIEF SUMMARY OF THE INVENTION

Certain embodiments of the invention employ systems and methods for applying materials over and/or onto soil within a predetermined geographical area. Some of these embodiments comprise at least one buffer configured to receive a measured amount of a material for injecting into the soil. Some embodiments comprise a propellant that pressurizes the measured amount of the material in the buffer. Some of these embodiments comprise a controller that measure the amount of material provided to the buffer and controls the pressurization of the material in the buffer. The controller causes the measured amount of the material to be released within a certain time. The controller calculates the amount of material. The controller calculates the pressurization. The controller calculates the certain time. The calculations of the controller provide a desired concentration of the material in the soil.

Certain embodiments of the invention provide systems for controlling the treatment of an area of soil. One or more tanks store chemicals for the treatment and a mixing chamber in an injector that mixes measured quantities of the chemicals and introduces the mixed chemicals to a stream of water to obtain a chemical mixture. In one example, a controller monitors the flow of chemicals and the stream of water and causes the injector to release discrete predetermined amounts of the chemical mixture into the soil at a sequence of injection points. In another example, a controller monitors the flow of chemicals and the stream of water and causes the injector to provide the chemicals to an irrigation system. The controller can provide a signal that pulses the stream of water, thereby controlling the volume and rate of delivery of water to the mixing chamber. Frequency and duty cycle of the signal are selected to obtain a desired concentration of chemicals in the chemical mixture and/or on a measurement of the rate of flow of a chemical to the mixing chamber.

In some embodiments, a propellant pressurizes the chemicals in the one or more tanks. The chemicals can comprise a plurality of chemicals and rate of delivery of each chemical to the mixing chamber may be independently controlled by the controller. The rate of delivery may be controlled by the rate of release of material from the buffer. Treatment points may receive chemical mixtures having different concentrations of chemicals and/or different amounts of the chemical mixtures. Quantity and concentration of the chemical mixture can be selected according to moistness of the soil at injection points and/or density of the soil at each injection point. Quantity and concentration of the chemical mixture at each injection point is selected based on a treatment plan identified by a user. Temperature of the chemical mixture at each injection point may also be controlled according to a treatment plan.

### BRIEF DESCRIPTION OF THE DRAWINGS

FIG. 1 shows an example of a delivery system according to certain aspects of the invention mounted an agricultural vehicle.

FIG. 2 is a schematic show a material delivery system according to certain aspects of the invention.

FIG. 3 is a flow chart showing a simplified process for operating systems constructed according to certain aspects of the invention.

FIG. 4A shows a three element injection device 40 according to certain aspects of the invention.

FIG. 4B shows an injector component of the injection device in FIG. 4A.

FIG. 4C shows an injection chamber of the injection device in FIG. 4A.

FIG. 4D shows a mixing chamber of the injection device in FIG. 4A.

FIG. 5 shows an embodiment of the invention used to treat an area using an irrigation system.

FIG. 6 is a block schematic of a processing system according to certain aspects of the invention.

FIG. 7 is a block schematic showing a processing system used in certain embodiments of the invention.

FIG. 8 shows a system level flow employed in certain embodiments of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise a dispensing system that be used to treat an area of soil and/or crops planted in the soil. Treatment may include disinfecting and/or preparing soils prior to planting. Treatment may include applying a pesticide and/or herbicide to crops planted in the soil. In one embodiment, a system can inject fumigant or chemicals into soil through a mobile subsurface injection apparatus. The fumigant and/or other chemicals can be applied from a moving vehicle or platform. In another embodiment, fumigant and/or chemicals can be delivered through an irrigation system that provides water through drip irrigation. In each of these examples, the dispensing system may be mounted and anchored on a vehicle during transportation and/or use. Typically, the dispensing system meters a predetermined volume of a chemical to obtain a desired concentration of material that may be provided to a drip irrigation system or dispersed into soil by injection or other means.

In one example, phytosanitary products comprising a mixture based on methyl-iodide (Iodomethane®) can be injected through irrigation systems, drop-by-drop. A precise mixture with one or more different products can be prepared and used in the system. Such mixtures may comprise Iodomethane, an aromatic agent and Adjuvant. Systems according to certain aspects of the invention facilitate transferring a plurality of different products to buffer tanks in order to prepare a desired mixture. The quantity of constituent products can be defined by users through a computer-based system that typically provides for user input through a display/keyboard transfer. The system typically controls one or more of the rate of injection, commencement and termination of injection and location of injection based on user defined parameters.

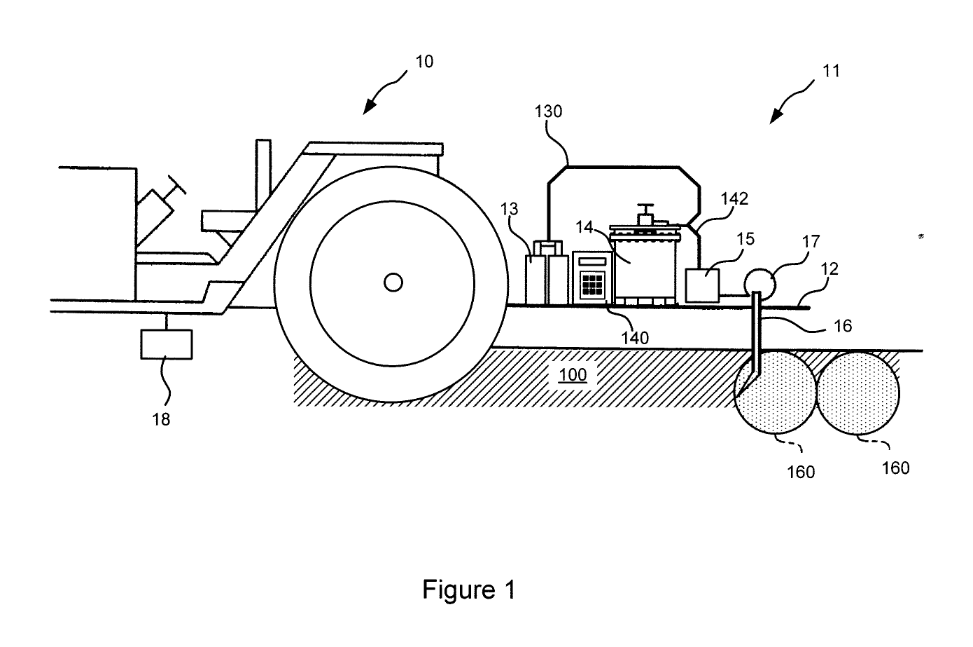

With reference to FIG. 1, the system may be mounted on a platform 12 attached to, or hauled by, a tractor 10 or other vehicle. Delivery system 11 may comprise an irrigating and/or injection system that employs, for example, a steam injection or gas driven system. In one example, a self-contained delivery system 11 provides materials through on-board injectors or drip nozzles. Accordingly, the system may treat an area continuously and/or may be moved between connection points of a drip irrigation system. In a drip irrigation system, delivery system 11 can determine flow rate of water, can control rate of flow of the water and can supply chemicals to the water flow in order to obtain a desired concentration of the materials. Aspects of the delivery system, which may comprise any combination of metering and irrigating components or individual components, can be precisely controlled to deliver a desired concentration of material by volume or by area treated. The material may be selectively delivered in liquid or gaseous states.

Delivery system 11 can comprise one or more storage tanks 14 that contain materials that can be applied to soil 100. One or more propellants may be stored in pressurized containers 13 and conducted to container 14 and/or to a mixer 15 and one or more buffers 17. Plural buffers 17 may also be arranged to receive material from containers 14 prior to combining the materials in mixer 15. The selection of mixer 15 and buffer 17 order may be determined by application specific factors including characteristics of individual materials and combinations of materials.

In certain embodiments, accurate delivery of materials can be obtained using a programmable control system 140. The control system 140 may be collocated with delivery system 11, as shown in the drawings. However, it is anticipated that portions of the control system 140 may be located remotely from injectors, chemicals and/or other chemical handling elements. In one example, control intelligence such as computers may be located remotely, including in a cab of vehicle 10 while valves and instrumentation is placed within delivery system 11. Communication between the separated components may be effected by wired or wireless means. Control system 140 may monitor operation of the system components and provide alerts if the system performs outside of specified operating ranges. Operating ranges may be configured through a plurality of parameters, and may be calculated based on a combination of factors, including materials used, dispensing equipment, terrain, soil properties and user configurable variables. Control system typically employ a communications interface to provide reports, receive commands, validate and verify operations and function of equipment, report errors, send alerts and so on. Communications may be provided wirelessly using cellular telephone networks, WiFi, WiMax, satellite, or any available wireless networking medium. Communications may also be accomplished indirectly using a docking system, removable storage or by wire connected to a base station or a mobile computing device.

In certain embodiments, communication with controller is bidirectional and comprises communication of information including one or more of rate delivery information and settings, field mapping, measured or anticipated moisture and temperature, identification of point of injection, flow rate of irrigation and so on. In one example, ambient temperatures of air and soil may be measured and compared to select a mix of materials, heating or cooling of materials, pressure and composition of propellant used to inject materials into the soil or into an irrigation stream.

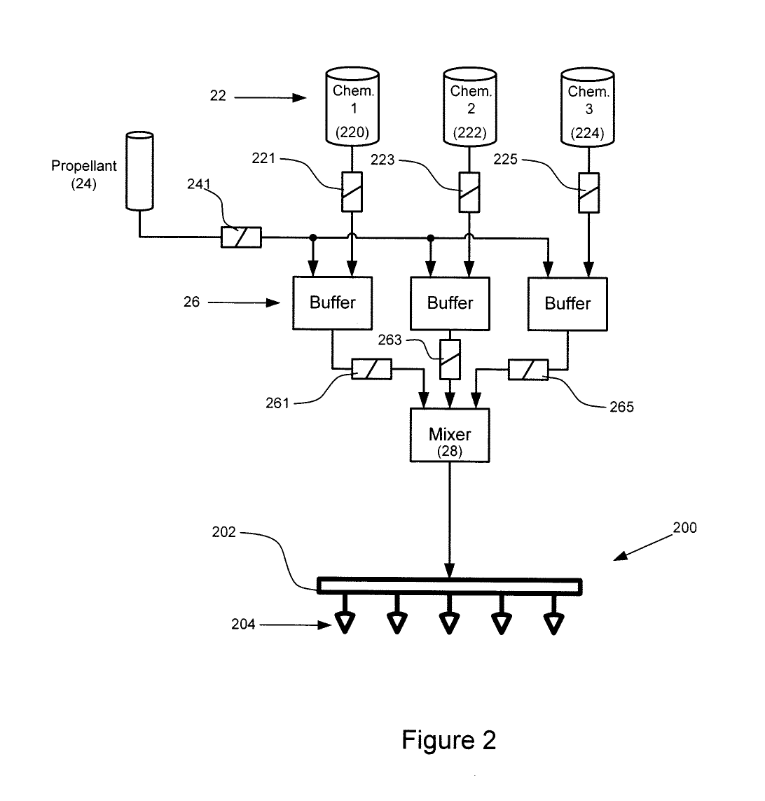

Certain embodiments provide a co-injection system that is configurable to permit the injection of a plurality of different materials and different concentrations of the materials. FIG. 2 shows one example of a co-injection system having a plurality of tanks 22 or other suitable storage vessels maintain chemicals for treatment of soil through a desired delivery mechanism shown generally at 200. In the depicted example, three tanks 220, 222 and 224 are shown, although the number of tanks and chemicals is not limited to two or three. Each tank 220, 222 and 224 supplies a chemical through corresponding valve 221, 223 and 225 (respectively) to a corresponding buffer (shown generally as 26). Buffers 26 can be used to pressurize chemicals 22 using propellant 24 regulated through valve 241. It is contemplated that each of valves 241, 221, 223 and 225 may be electronically controlled. In some embodiments, propellant 24 for each buffer 221, 223, and 225 may be independently regulated. Buffers 26 provide respective chemicals to a mixing chamber 28 using valves 261, 263 and 265, prior to injection through injector nozzles 204. In another example, mixing chamber 28 provides mixed chemicals to a drip irrigation feed 202 from which delivery is completed through nozzles 204 that may be located above or below the soil.

More than one material 22 may be simultaneously used for treatment of soils, plants and/or crops and/or mixed prior to treatment. Mixing may be performed in-line using mixer 28 such that combinations of materials 22 may be selected dynamically during operation, typically prior to delivery at the point of injection. By mixing materials 22 as they are transmitted to nozzles 204, adverse effects of chemical interactions can be minimized. For example, corrosion of mixing tank 28 can be avoided if mixing occurs as needed and physically close to point of application.

According to certain aspects of the invention, the composition of a propellant 24 may be selected based on environmental conditions and the selected combination of chemicals 22 to be delivered through the injection/irrigation system 200. For example, certain conditions may dictate the use of an inert propellant such as nitrogen (N₂), while other conditions may indicate the use of pressurized water or steam as a propellant. For example, steam may be used to assist mixing of the materials. In certain embodiments, a controller may execute configurable software that controls various aspects of the injection of materials. The controller may be configured to control quantity of materials 22 to be applied, an injection time allowed for a discrete predetermined quantity of material to pass through the injectors/irrigation system 20 and a period of time between applications. In certain embodiments, the controller may control a flow rate of a fluid passing through the injection/irrigation system 200, thereby controlling the quantity of chemicals applied to a target area.

Controller typically receives input from sensors that can be collocated with valves 221, 223, 225 of the individual materials 22, with one-way pressure regulators/compensators 261, 263 and 265 that maintain a predetermined flow and time to inject measured amounts of materials 22, which may be held in buffers 26. Similarly, regulators/compensator 241 can control flow of propellant 24. It will be appreciated that, in many embodiments, some sensors will be coupled to the system at other points. In one example, pressure and temperature sensors monitor tubing that communicates materials to be injected and pressure and temperature measurements may be used to control flow rates of injection and detect fault conditions in the dispensing systems. In some embodiments, concentrations of chemicals may be controlled by controlling the rate of delivery of propellant. For example, water propellant may be pulsed based on measured pressures of available chemicals and desired concentration levels. Rate and duration of pulses determines the amount of water arriving at buffer tanks 26 (or at mixer 28) while chemicals from tanks 22 arrive at affixed rate. In this manner, the concentration of chemicals provided to mixer 28 can be controlled.

In certain embodiments, tanks 22 and 26 are monitored and metered. It is contemplated that buffer tanks can be eliminated from some embodiments, particularly when chemicals can be accurately metered, measured and controlled in other ways. The delivery system may be pressurized using an inert gas, and chemicals can be delivered to mixer 28. In one example, output of mixer 28 is fed to an irrigation line (e.g. line 202) and deployed through nozzles 204 as a spray, mist or jet. In another example, nozzles 204 may be inserted into the soil using shanks deployed from a mobile apparatus. The concentration of chemicals injected through nozzles 204 may be controlled by pulsing a water feed or otherwise controlling flow rate of the water. Pumps may also be used to deliver chemicals to mixer 28 and/or to control rate of flow into water in water line 202. Typically, rate of delivery of mixed chemicals by mixer 28 is controlled to obtain a target concentration, typically measured in parts per million.

Sensors used to determine environmental conditions can include remotely located position detection sensors that may be accessed by the controller to determine location of delivery system and/or nozzles 204 with a desired degree of accuracy. In one example, position detection sensors are based on GPS navigation systems. In certain embodiments, operational characteristics of the system are recorded by the controller and used to determine status, provide early warning of material depletion or failure of equipment. In one example, the weight of containers that supply materials for injection may be monitored. The current weight of a container, when compared with a Tare weight, can determine a net weight of available material for injection. Changes in net weight can be monitored to confirm rate of injection of the material.

In certain embodiments, a controller may cooperate with a central processor and/or other controllers of other dispensing systems to coordinate material delivery. Vehicle 10 may carry a plurality of dispensers 204 that inject different materials at different points, depths and/or in a timed sequence. The rate of flow and timing of injection may be coordinated between the controllers. Central processor may provide operational parameters to the controllers for timing and measuring materials for delivery. Controllers and/or central processor may select materials and the rate and timing of their delivery based on operating parameters that may include material selection and/or preference of an operator, characteristics of soil and/or a target crop, identified pest and/or disease to be controlled, and other agronomically significant factors.

Certain embodiments account for variations in soil to be treated. In one example, a treated area may include zones in which moisture of the soil varies considerably. One zone of an area to be treated may receive prolonged exposure to direct sunlight while other zones are shaded by vegetation, topography, etc. Furthermore, portions of the treatment area may be adjacent to water sources such as drainage channels, streams while other portions may be distant from such sources. The effect of water tables can cause significant differences in moisture of soil. Accordingly, the controller may adjust a mixture and/or density of certain materials in response to changes in wetness of soil. Adjustment may also be made to account for changes in acidity, alkalinity and the presence of chemical compounds. Additional materials can be added and/or concentration of materials can be adjusted to facilitate operation of materials introduced to the soil. Adjustments may be made based on user input and/or based on a mapping of characteristics of the area to be treated.

Certain embodiments of the invention comprise a subsurface soil injection system in which the pattern of injection points may be configured dynamically to accommodate changes in moisture, absorption, temperature, acidity, alkalinity and soil composition. The patter of injection points, when coordinated with the quantity of material introduced to the soil can determine a dispersion pattern 160 of the material in the soil 100. The dispersion pattern is also affected by the characteristics of the soil and a controller according to certain aspects of the invention can selectively adjust the quantity of material introduced at each injection point, as well as the position and relative locations of injection points to obtain a desired degree of uniformity of dispersion in a treatment area.

Certain embodiments employ a mapping function that is used to calculate concentrations of chemicals and rate of flow of chemical mixtures based on known characteristics of the treatment zone. In a subsurface injection system, the mapping system can enable variable flow rates of materials through the injectors. In a drip irrigation system, the mapping system may be used to pre-configure flow rates and concentrations. Mapping may use GPS or other position locators to control changes in flow and mix of materials. Mapping information may also include a history of prior injections at the location to be treated. Additionally, an operator may map regions to be treated in a particular manner. Mapping may be performed on a graphical display and/or may comprise a “walkthrough” process in which the operator traverses the area to be treated and marks regions requiring particular attention using a GPS or other locational service. In one example, an operator may provide an input to controller while applying material during one pass through the area to be treated, whereby the controller marks the position at which the input was received. The input could mark sandy soil, wet soil, insect infested regions, reach of drip irrigation pipes and hoses, and so on.

In certain embodiments, a planning system may be employed to generate treatment plans. The planning system may comprise a proprietary or commercially available geographical information system or other tools that combine information gathered before and during treatment with GPS generated information.

Certain embodiments of the invention can dynamically control and manipulate the physical state of materials to be introduced to the soil of a treatment area. The physical state of certain materials may dictate whether the materials can be introduced on or close to the surface of soil to avoid rapid dispersal into the air. In some embodiments, it may be desirable to introduce some materials at different depths. For example, in a subsurface injection system, the depth at which material is injected can be controlled to reduce evaporation rate of a fumigant or other material. Accordingly, certain embodiments can control both the physical and chemical characteristics of a material and the depth or rate of application. For example, the pressure and temperature at which a material is dispersed can be manipulated to ensure a liquid or gaseous phase material is provided at the point of application. The content and proportions of a mixture may be adjusted and/or augmented to obtain a change in phase transition points, viscosity, solubility, etc.

In certain embodiments, temperature and pressure can be adjusted dynamically to obtain site-specific material application states. In one embodiment, material can be passed through a heat exchange component as it is transmitted to injectors or drip nozzles. The heat exchange component may be used to selectively heat and cool the material prior to injection or application to the soil. In an injection system, pressure can be electronically controlled, typically by controlling the pressure of a propellant used to drive the material through the injector nozzles.

In one example, heat exchange can be accomplished by passing material through heat conducting tubing immersed in a temperature controlled fluid. Furthermore, one or more reservoir of materials can be immersed in heat controlled fluid such that the material is pre-heated or pre-cooled before release to the injector nozzles. In another example, a propellant such as pre-heated nitrogen or steam may be used to heat the material as it propels the material towards and through the injectors. Heating can be accomplished using propane burners, electrical immersion coil as desired. In some embodiments, a pre-cooled propellant (e.g. liquid nitrogen) and/or a conventional refrigeration system may be used to cool the material as necessary.

Certain embodiments provide a co-injection system having a plurality of separate, monitored injection ports. In one example, a co-injection system is provided that permits three separate and monitored injection ports that can avoid corrosion issues associated with blending of certain chemical compounds (e.g. Midas and NutraPic 500). It will be appreciated that two or more ports can be used in a co-injection system. Typically, the number of ports is limited by physical constraints related to size of a mixing component. Therefore, certain embodiments may employ a multi-stage co-injection system, whereby mixing of chemicals can be injected at subsequent stages and/or in a sequence of injection modules. It will be appreciated also, that some embodiments provide a mixing tank for some or all of the chemicals to be mixed.

Ports may be monitored for pressure temperature and presence of chemicals and dosage can be automatically calculated and recorded. Dosage calculations typically include calculating quantities of constituents to deliver a desired concentration and volume. For example, dosage may be calculated as parts per million in irrigation water delivered, based on soil type, target rate, water flow and water volume (in cubic mm) to be applied by drip irrigation systems. Water flow and/or pressure can be adjusted in real time and reports of dosage, faults and treatment plans can be provided during application.

Systems constructed according to certain aspects of the invention typically comprise in-line static mixers that may be mechanical in nature, or may involve no moving parts. Systems are typically constructed for mobility and energy independence, employing batteries, solar panels, fuel cells, generator, dynamo and/or other mechanically generated power or power from a towing vehicle to supply control systems.

Certain aspects of the invention reduce worker exposure to potentially harmful chemicals. Mixing is typically performed as needed (outside the greenhouse) in a closed system that requires no direct handling of materials by the applicator. Because the system is closed, monitored and computer controlled, risk of leaks and spills is substantially reduced. In particular, control systems can automatically stop flow of material and shut off sources when fault conditions are detected. For example, shutoff can be initiated if water flow stops in an irrigation system, ff pressure anomalies are detected, temperature changes occur or some other abnormal measurement is made. In some embodiments, a shut down procedure is defined that includes an automatic flush and that can be initiated after treatment is completed, upon fault detection and/or prior to servicing the equipment.

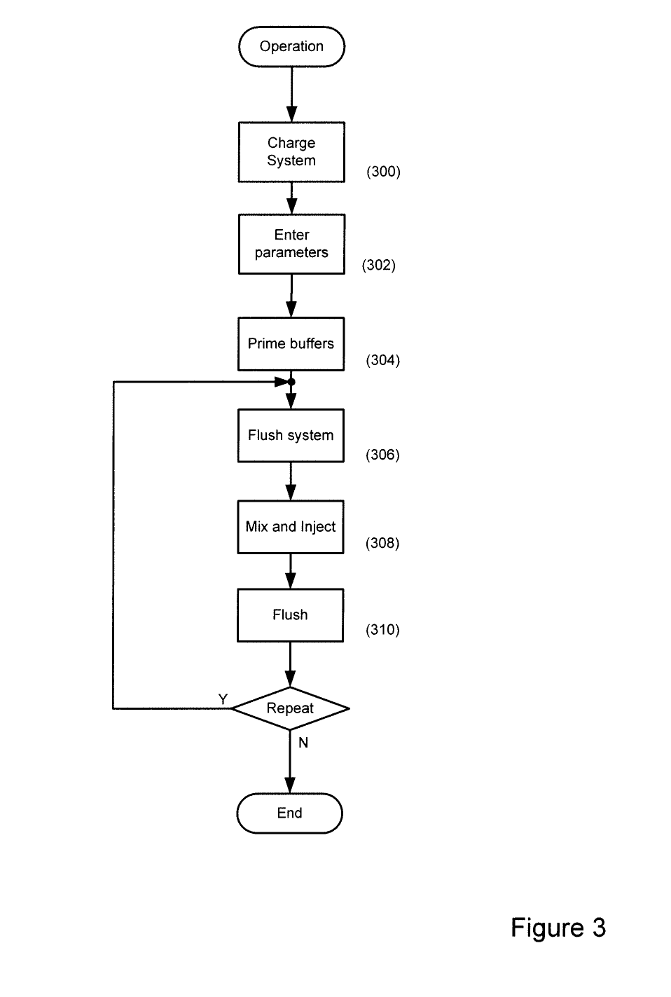

FIG. 3 is a flow chart showing a simplified process for operating systems constructed according to certain aspects of the invention. At step 300, storage containers for the component chemicals are pressurized. Storage containers may be refillable or may be replaced when depleted. Because different constituent chemicals may be used, the control system is typically configured at step 302. Configuration typically includes setting parameters that identify the contents of available storage containers and propellants into a system controller prior to operation. Identification of the container contents, concentration and intended use may be entered by an operator into a control panel or through other means. For example, a barcode or RFID scanner may be used to scan an identifier attached to a container, the identifying information then being transmitted to the controller wirelessly or by wired connection. The name and quantity of product is typically used in calculating the mixture, concentration, rate of injection and other characteristics and properties needed for treatment. Other information may be entered including, for example, weight of the container when empty, expiration dates and so on.

An operator may generate an application plan by configuring the controller using parameters, template settings and other information. Parameters can include rates of flow, concentration levels, water flow, pressures, total time of treatment, total area to be treated and characteristics of the area to be treated. Additionally, GPS coordinates, or their equivalent, may be entered to locate and characterize an area to be treated. Characteristics of the area to be treated may be provided using a mapping application, by user input, etc. Characteristics may include soil type, topography, acidity, proximity to water table, shade and so on.

At step 304, one or more buffer tanks may be primed by filling the tanks from storage containers. A buffer tank may be used to pressurize material, to premix, hydrate, heat, cool or otherwise prepare one or more of the constituents to be mixed. Tubing of the delivery system may be flushed at various stages of the process, including during the priming step 304. Flushing can be accomplished using an inert fluid, a propellant and/or a reactant. Typically, fluids such as water or N₂ are used for flushing. Priming can also include a step of pressurizing the buffer tanks using a propellant.

The system may perform a check to ensure that valid parameters have been entered (see step 302) and that the parameters and objectives of the treatment provided to the controller can be performed with the available chemicals. Input from sensors may be checked and any updates provided by users may be incorporated before operations begin. Parameters typically include information regarding surface to be treated, wetting, dose, density and flow variability. A successful validation of system and system parameters may be required before priming at step 304.

Having completed optional self-checking, the system may be enabled. Treatment typically includes one or more cycles that comprise flushing at step 306, mixing and injection at step 308 and flushing at 310. Flushing is used to purge mixing, pressurization, heat exchange and other equipment as well as tubing and irrigation pipes. Flushing may be performed as a calculated automatic system purge. In some embodiments, an additional machine rinsing step is performed with water, whereby the system is pressurized with N₂ or another inert gas.

System shutdown may be performed, after the treatment plan has been completed, a terminating command has been received from a user and/or upon receiving an error alert from system sensors. System shutdown may include terminating flow from chemical storage tanks 22 and an optional flushing cycle to remove any remaining chemicals from the mixing and injection systems.

One example of a system according to certain aspects of the invention mixes one or more chemicals for fumigation of soil. For the purposes of this discussion, it will be assumed that one of the chemicals is methyl iodide (Iodomethane) and that the propellant and/or solvent comprises water. Water flow can be monitored using ultrasonic transducers and water delivery may be controlled by pulsing. Thus, the rate and duration of water pulses can be used to control the volume of water provided to a mixing chamber or tank. Flow of the methyl iodide and one or more other chemicals can be controlled by monitoring pressure in feed lines. By monitoring and controlling the flow rates of the chemicals, solvents and/or propellants, a consistent concentration of the various chemicals can be provided by the system for injecting into the soil. In one embodiment, mixing may occur in a tank that receives solvent and chemicals and from which the mixture is driven in predetermined quantities by a propellant according to a calculated injection schedule. In another embodiment, a co-injection system uses an in-line mixing element (see below) that receives the controlled feeds of chemicals and solvents. Output may be controlled by pulsing an on/off valve according to a calculated injection schedule.

The system described in the latter example may calculate an injection schedule based on factors such as speed at which the injection apparatus travels across the area to be treated, the nature of the soil and variations in soil characteristics over the area to be treated. Speed may be determined using radar and/or ultrasonic components that detect translations of the equipment over the area to be treated. It will be appreciated that GPS-based systems and radio triangulation can also be used, as could more traditional speedometers and motion detection systems.

The system can be configured to detect one or more abnormal conditions and to perform an emergency procedure to reduce exposure and other threats. Abnormal conditions include lack of water, leaks, blockage or clogs, over-pressure and other conditions.

Certain embodiments provide reports describing treatment process and fault detections. Reported information can include date, start and end time of treatment, surface treated, product used, dose applied, wetting and rate of delivery. Ambient conditions and status of equipment may be reported. Reports can be provided electronically and/or in hard copy. Electronic reporting may be used to populate a database or historical archive and may be used as an input for future treatments.

Certain embodiments of the invention deploy mixtures of chemicals that may be corrosive alone or in combination, that are reactive with respect to one another, that are otherwise chemically incompatible and/or that pose a health hazard when handled alone or in combination. Accordingly, certain embodiments employ injectors and mixers that minimize hazards associated with the mixing of chemicals. Responsive to the computer controlled injection systems described herein, the injectors and mixers receive and mix chemicals, propellants and solvents before communicating the resultant mixtures to an application system that deposits materials directly into the soil.

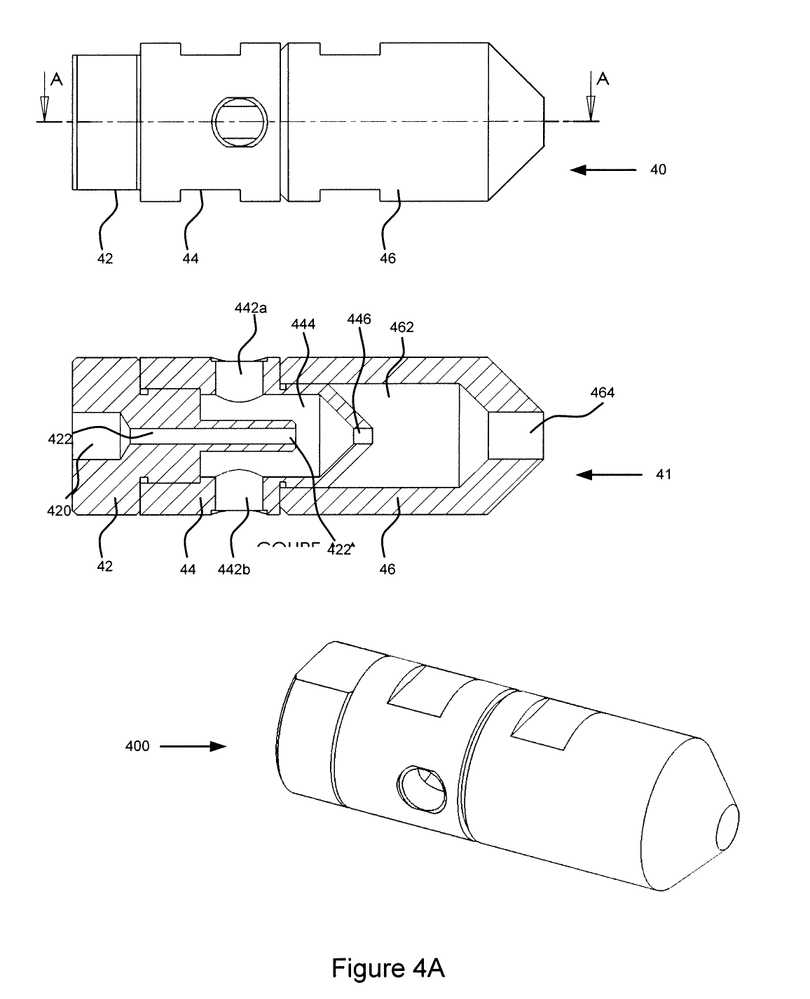

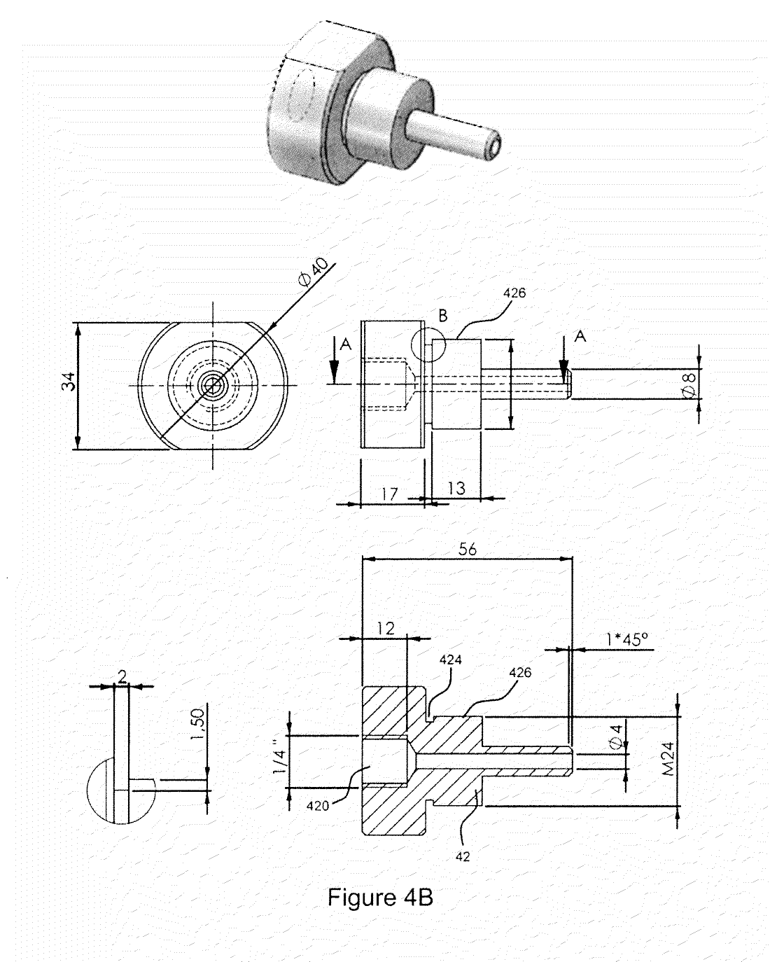

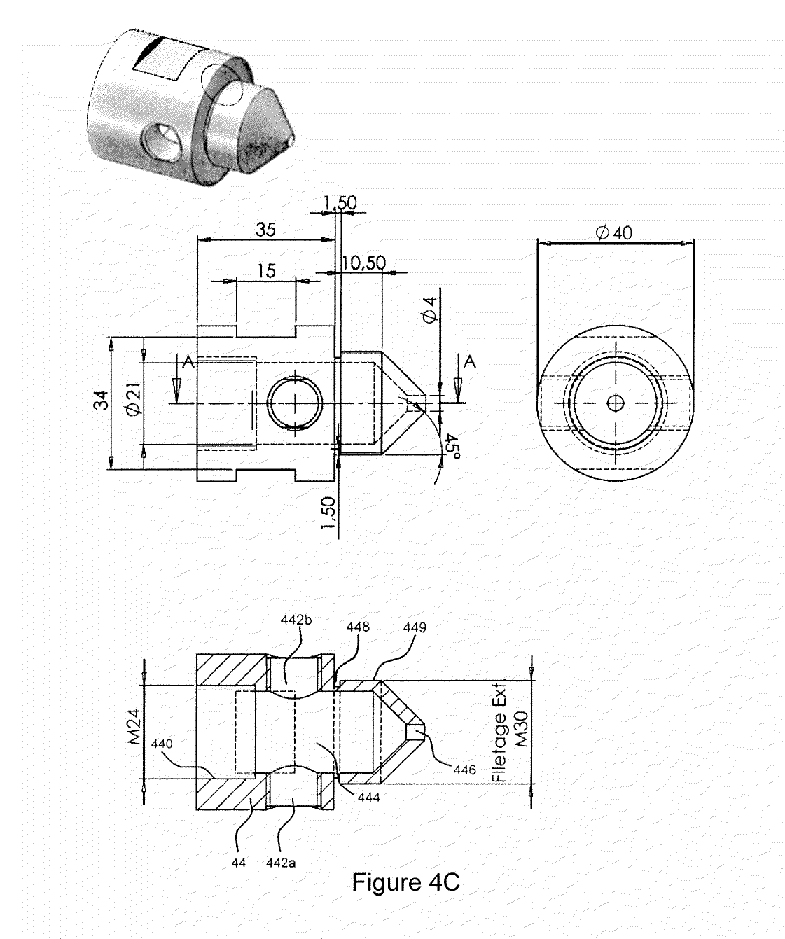

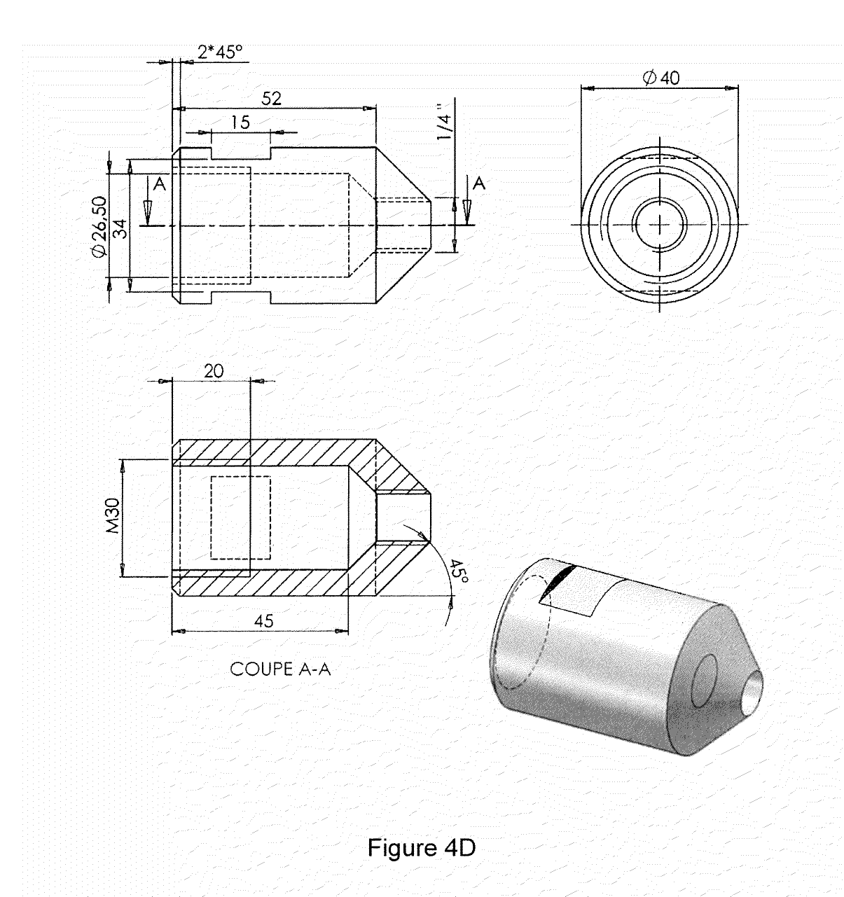

FIGS. 4A-4D show an example of an electronically controllable injector 40. In FIG. 4A, an example of a three element device 40 comprises an injector 42, an injection chamber 44 and a mixer 46, also shown in cross-sectional view at 41. Injector 42 is shown in more detail in FIG. 4B. Injector 42 receives a propellant at port 420. Responsive to a signal, the propellant is admitted to injector 42 through convergent nozzle 422 which typically accelerates the propellant. According to certain aspects of the invention, the signal may cause the pressurized propellant passing through convergent nozzle 422 to be pulsed in order to control the rate of flow and/or concentration of the injected materials. For example, the signal may alternately enable and disable the flow of propellant water, such that the volume of water passing through nozzle is determined by the duty cycle of the pulsed signal. The volume of water may be selected to adjust concentration of chemicals leaving injector 40.

Propellant may comprise nitrogen or another gas, water, steam or another fluid selected according to the application at hand. A propellant can be selected based on its non-reactivity with chemicals to be delivered by the injection system to an area and/or may be selected based on an ability to dissolve one or more of the chemicals to be delivered by the injection system. In some instances, propellants such as compressed air may be used if the reactive constituents have limited effect. The injector element 42 is typically tightly fitted to an injection chamber 44. Injector element 42 may comprise a groove 424 that facilitates locking injector 42 to chamber 44 and that optionally receives a gasket or sealant. In some embodiments, injector 42 may be attached to injection chamber 44 using a screw thread provided on a surface 426 of injector 42 that mates with internal thread of surface 440 of injection chamber 44.

FIG. 4C shows different views of injection chamber 44. Accelerated propellant enters cavity 444 of injection chamber 44 and exits through exit port 446 into mixing chamber 46. The increased speed of propellant results in reduced propellant pressure measured in cavity 444 that draws chemicals through ports 442a and 442b into mixing chamber 46. Sealing between injection chamber 44 and mixing chamber 46 may be accomplished through tightness of fit and/or through the use of a sealant or gasket and/or washer installed using, for example groove or notch 448. In some embodiments, injection chamber 44 and mixing chamber 46 using a screw thread provided on a surface 449 that mates with internal thread of surface 460 of mixing chamber 46.

FIG. 4D shows different views of mixing chamber 46. Accelerated propellant laden with chemicals introduced through ports 442a and 442b expands into cavity 462 of mixing chamber 46 where chemicals mix before passing through narrow exit port 464. Typically, the expansion of propellant and the chemicals results in turbulence that facilitates mixing of chemicals with the propellant. When the propellant comprises water or another solvent, the turbulence can assist chemicals dissolve in the propellant. In some embodiments, the turbulence may help create an emulsion. To assist the formation of an emulsion, an emulsifier may be introduced with the propellant or through an available port 442a or 442b.

In one example, exit port 464 of mixing chamber 46 is larger than the exit port 446 of injection chamber and may receive tubing that conducts mixed chemical and propellant to a static mixer of an irrigation line or to a nozzle of a subsurface injection system. A spike and/or shank may be used to position one or more of the injector 40 and a nozzle below the surface of the soil. In at least some embodiments, flattened surfaces and/or notches 466 may be provided on the outer surfaces of mixing chamber 46 to facilitate manipulation and fastening using a wrench or other tool.

A variety of materials can be used to construct embodiments of the invention. Certain embodiments employ combinations of stainless steel, superalloys, polyvinylidene fluoride (“PVDF”), PTFE, glass, ceramics, rubber and various polymers. Grade 316 stainless steels, including grade 316L low carbon stainless steel, are particularly effective in resisting corrosion by halides and the like. Superalloys include corrosion resistant alloys of nickel and other metals that can comprise percentages of metals such as molybdenum, chromium, cobalt, iron, copper, manganese, titanium, zirconium, aluminum, carbon, and tungsten. M-class rubbers (e.g. EPDM) may be used in certain components.

In certain embodiments, injector 42, injection chamber 44 and mixer 46 can be constructed from stainless steel although other materials can be used, including polymers, composites, ceramics and so on. In one example, Grade 316L stainless steel may be used. Grade 316L is molybdenum-bearing steel, characterized by its corrosion resistant properties that include high resistance to pitting and crevice corrosion in chloride environments.

In certain embodiments, the injection system may be instrumented at any of a variety of points. Chemical feeds, mixing chambers and injectors may include integral sensors and/or ports to which instrumentation can be coupled. Because of the corrosive nature of many chemicals that can be used with embodiments of the invention, sensors, tubing and fasteners may include protective layers or may be constructed from inert materials. For example, surfaces of pressure sensors may comprise housings constructed from stainless steel, polyvinylidene fluoride (“PVDF”) and/or glass. Pressure sensors may also comprise PVDF sensing elements, PVDF or PTFE interface and PTFE O-ring seals. Hoses and tubing may be manufactured from PTFE and/or be provided with PTFE internal surfaces and ball-valves may include PTFE seats.

### Computing System

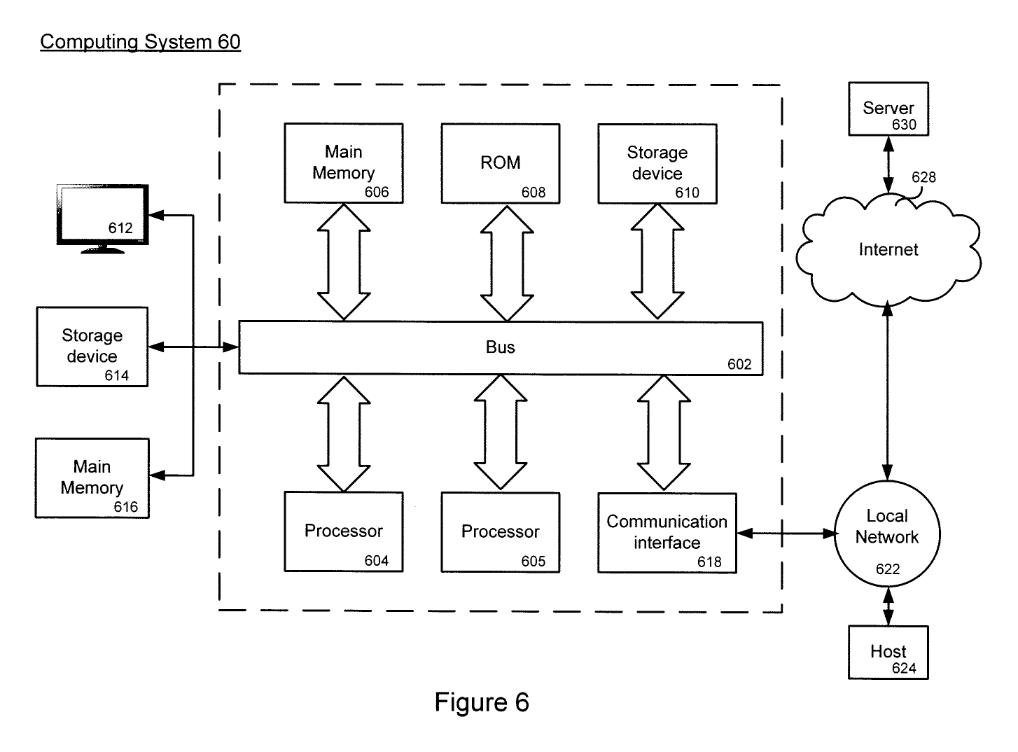

Turning now to FIG. 6, certain embodiments of the invention employ a controller that comprises a processing system 600 deployed to perform certain of the steps described above. Processing system 600 may include a commercially available system that executes commercially available operating systems such as Microsoft Windows®, UNIX or a variant thereof, Linux, a real time operating system and or a proprietary operating system. In one example, processing system 600 comprises a bus 602 and/or other mechanisms for communicating between processors, whether those processors are integral to the computing system 60 (e.g. 604, 605) or located in different, perhaps physically separated computing systems 600.

Processing system 600 also typically comprises memory 606 that may include one or more of random access memory (“RAM”), static memory, cache, flash memory and any other suitable type of storage device that can be coupled to bus 602. Memory 606 can be used for storing instructions and data that can cause one or more of processors 604 and 605 to perform a desired process. Main memory 606 may be used for storing transient and/or temporary data such as variables and intermediate information generated and/or used during execution of the instructions by processor 604 or 605. Processing system 600 also typically comprises non-volatile storage such as read only memory (“ROM”) 608, flash memory, memory cards or the like; non-volatile storage may be connected to the bus 602, but may equally be connected using a high-speed universal serial bus (USB), Firewire or other such bus that is coupled to bus 602. Non-volatile storage can be used for storing configuration, and other information, including instructions executed by processors 604 and/or 605. Non-volatile storage may also include mass storage device 610, such as a magnetic disk, optical disk, flash disk that may be directly or indirectly coupled to bus 602 and used for storing instructions to be executed by processors 604 and/or 605, as well as other information.

Processing system 600 may provide an output for a display system 612, such as an LCD flat panel display, including touch panel displays, electroluminescent display, plasma display, cathode ray tube or other display device that can be configured and adapted to receive and display information to a user of processing system 600. In that regard, display 612 may be provided as a remote terminal or in a session on a different processing system 600. For example, a planning system may be implemented that processes mapping and other diagrams indicating the treatment plan under control of an operator or other user. An input device 614 is generally provided locally or through a remote system and typically provides for alphanumeric input as well as cursor control 616 input, such as a mouse, a trackball, etc. It will be appreciated that input and output can be provided to a wireless device such as a PDA, a tablet computer or other system suitable equipped to display the images and provide user input.

According to one embodiment of the invention, portions of the planning system may be performed by processing system 600. Processor 604 executes one or more sequences of instructions. For example, such instructions may be stored in main memory 606, having been received from a computer-readable medium such as storage device 610. Execution of the sequences of instructions contained in main memory 606 causes processor 604 to perform process steps according to certain aspects of the invention. In certain embodiments, functionality may be provided by embedded computing systems that perform specific functions wherein the embedded systems employ a customized combination of hardware and software to perform a set of predefined tasks. Thus, embodiments of the invention are not limited to any specific combination of hardware circuitry and software.

The term “computer-readable medium” is used to define any medium that can store and provide instructions and other data to processor 604 and/or 605, particularly where the instructions are to be executed by processor 604 and/or 605 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 604 and 605 or remotely, typically by use of network connection. Non-volatile storage may be removable from computing system 604, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of processing system 600. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 604 and/or 605. For example, the instructions may initially be retrieved from a magnetic disk of a remote computer and transmitted over a network or modem to processing system 600. The instructions may optionally be stored in a different storage or a different part of storage prior to or during execution.

Processing system 600 may include a communication interface 618 that provides two-way data communication over a network 620 that can include a local network 622, a wide area network or some combination of the two. For example, an integrated services digital network (ISDN) may used in combination with a local area network (LAN). In another example, a LAN may include a wireless link. Network link 620 typically provides data communication through one or more networks to other data devices. For example, network link 620 may provide a connection through local network 622 to a host computer 624 or to a wide are network such as the Internet 628. Local network 622 and Internet 628 may both use electrical, electromagnetic or optical signals that carry digital data streams.

Processing system 600 can use one or more networks to send messages and data, including program code and other information. In the Internet example, a server 630 might transmit a requested code for an application program through Internet 628 and may receive in response a downloaded application that provides for the anatomical delineation described in the examples above. The received code may be executed by processor 604 and/or 605.

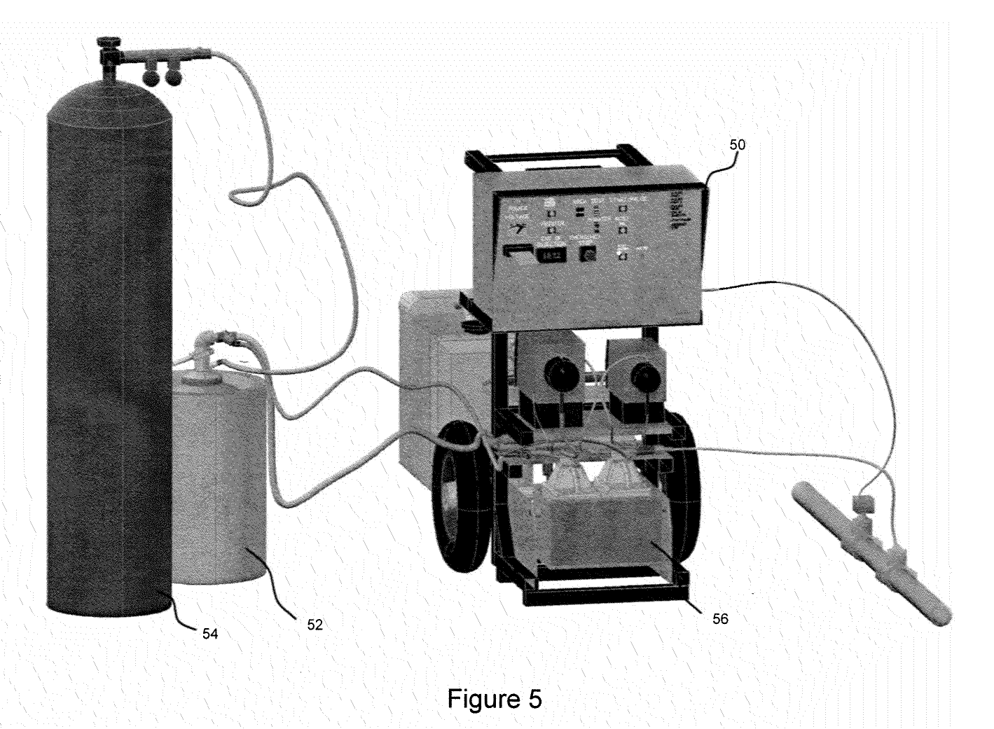

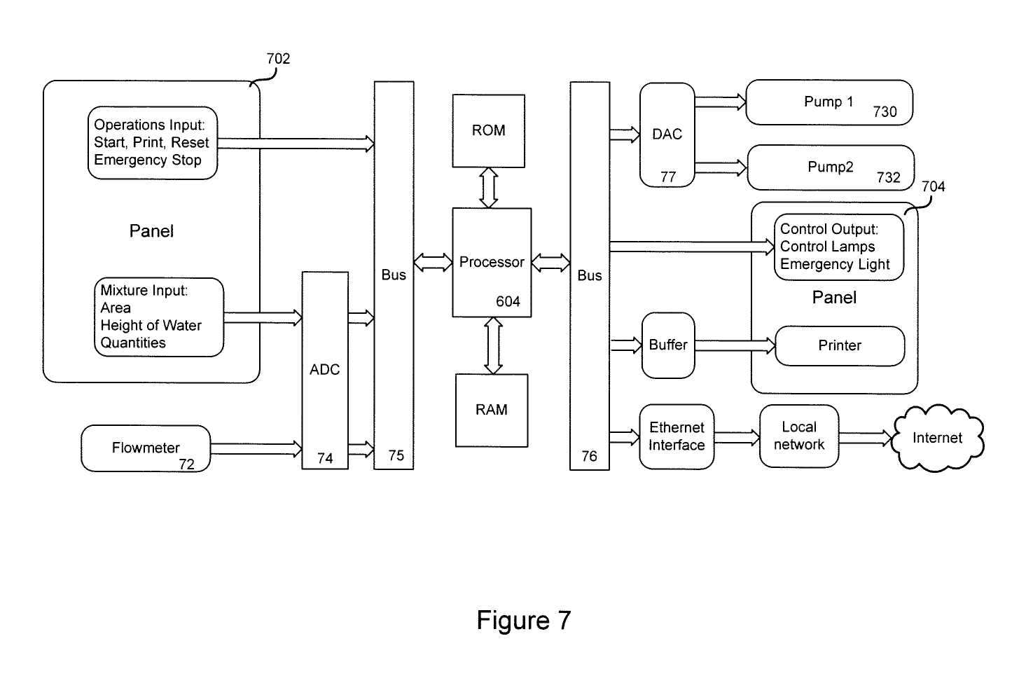

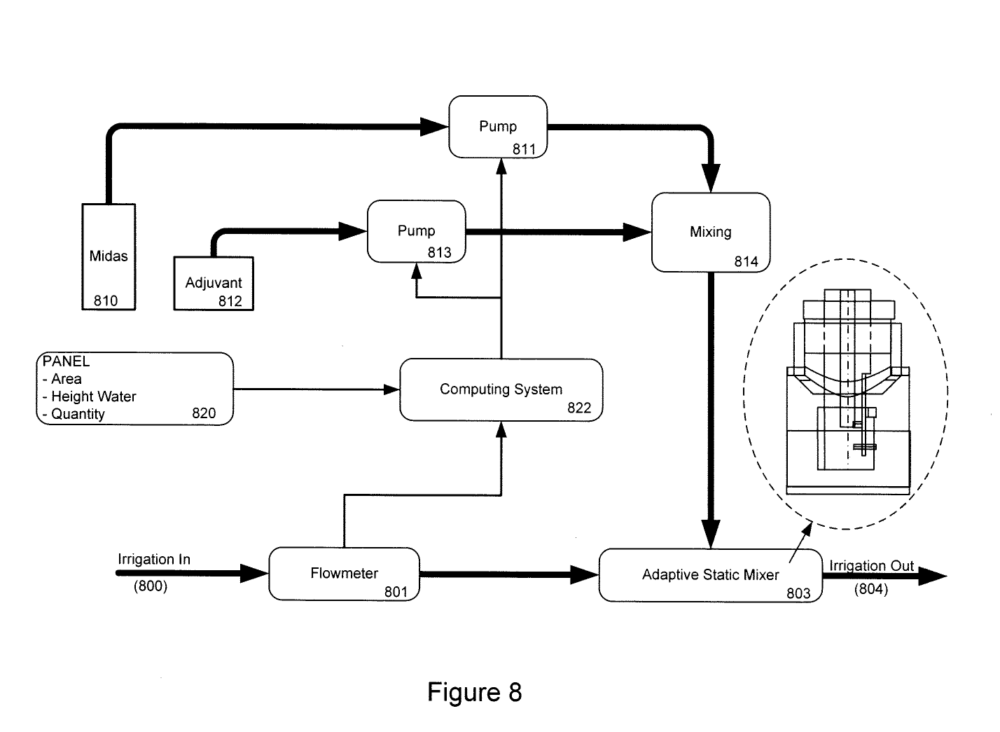

FIG. 5 shows one embodiment of the invention configured for use with a drip irrigation system. FIG. 7 shows an example of a computing system used to control operation of the embodiment of FIG. 7 and FIG. 8 depicts a corresponding process flow according to certain aspects of the invention. For the purposes of this description, it will be assumed that the system of FIG. 5 is configured to provide a desired mix of chemicals to a drip irrigation system, which delivers the chemicals in irrigation water to the soil and/or to crops that are growing in the soil.

A processor 604 interacts with input devices using an input bus 75 and outputs using output bus 76. Flow-meter 72 measures rate of flow of water in the irrigation system in order to determine the rate at which chemicals are delivered for mixing. An analog-to-digital converter (“ADC”) 74 digitizes the output of flow-meter 72. In some embodiments, the flow can be measured by a device that provides a digital output. ADC 74 may also be used to receive and convert signals provided by user input devices. For example, throttle-like devices, potentiometers and other analog transducers may be used to adjust levels set by user at an input and/or input-output panel 702. Input panel 702 may also provide digital signals and/or on/off signals to processor 604.

Processor 604 executes one or more algorithms that process inputs and control operation of system, including mixing of chemicals. Mixing chemicals may be effected by controlling the rate of pumping of chemicals using one or more pumps 730, 732. Pumps may be controlled digitally using, for example, a stepping motor driven pump. In some embodiments, pumps 730, 732 can be driven by an analog signal generated by one or more digital-to-analog converters 77 using a numerical representation of the rate of pumping. In some embodiments, pumps 730, 732 can be controlled by the frequency of an analog signal. Output panel 704 may be provided separately from, or as part of, input panel 702 and output panel 704 may provide indications to a user using some combination of a graphics or alphanumeric display, lamps, audio devices such as buzzers, horns, etc.

FIG. 8 depicts an illustrative process flow according to certain aspects of the invention. In the example, chemicals can be mixed according to a desired formula and introduced to an irrigation system for application to the soil. The illustrated irrigation system typically delivers water in spray, mist or jet form to the soil and/or to crops that are growing in the treated area. A flow-meter measure the rate of flow of water 800 in the irrigation system. Computing system 822 monitors the rate of flow of water and controls pumps 811 and 813 to provided desired flows of chemicals 810 and 812, respectively, to mixing chamber 814, which provides the calculated concentration of chemicals 810 and 812 to mixer 803. Mixer 803 can be configured to introduce the chemicals continuously or in pulsed manner to the irrigation system water 800 in order to produce treated fluid 804. It will be appreciated from the descriptions above, that chemical mixing 814 and adaptive static mixing 803 may be performed in a single mixing element. Computing system 822 may receive control input from user panel 820.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems, methods and apparatus for treating and/or irrigating soil. Some of these embodiments comprise one or more tanks that store chemicals for treating one or more of soil and crops planted in the soil. Some of these embodiments comprise an injector having a plurality of ports, each port receiving a flow comprising one of the chemicals. In some of these embodiments, the injector has a mixing chamber that mixes the chemicals received at the ports with a medium. In some of these embodiments, the injector provides a mixture of the chemicals in the medium. Some of these embodiments comprise a controller configured to control the rate of flow of the medium. In some of these embodiments, the rate of flow of the medium is selected to obtain a desired concentration of the chemicals in the mixture. In some of these embodiments, the mixture is provided to a delivery system that treats an area of land.

In some of these embodiments, the medium comprises a propellant, which may be inert, and the mixture is provided to one or more injectors that introduce the mixture to soil beneath the surface of the area of land. In some of these embodiments, the propellant comprises pressurized water. In some of these embodiments, the mixture is introduced to the soil in predetermined amounts and at a plurality of injection points. In some of these embodiments, some of the injection points receive chemical mixtures having different concentrations of the chemicals than other of the injection points. In some of these embodiments, quantity and concentration of the chemical mixture is selected according to moistness of the soil at each injection point. In some of these embodiments, quantity and concentration of the chemical mixture is selected according to density of the soil at each injection point. In some of these embodiments, quantity and concentration of the chemical mixture at each injection point is selected based on a treatment plan provided by a user. In some of these embodiments, temperature of the chemical mixture at each injection point is selected based on a treatment plan provided by a user.

In some of these embodiments, the medium comprises a stream of water and the mixture is provided to an irrigation line that irrigates the area of land. In some of these embodiments, the controller provides a signal that pulses the stream of water to control the concentration of chemicals. In some of these embodiments, frequency and duty cycle of the signal are selected to obtain a desired concentration of chemicals in the chemical mixture. In some of these embodiments, the frequency and the duty cycle are selected based on the rate of flow of the chemicals to the mixing chamber. In some of these embodiments, the rate of delivery of each chemical to the mixing chamber is independently controlled by the controller. Some of these embodiments comprise a plurality of buffers, each buffer controlling the flow of one of the plurality of chemicals responsive to the controller.

Certain embodiments of the invention provide methods for treating an area of land using irrigation water. Some of these embodiments comprise controlling rate of flow of a water supply. Some of these embodiments comprise providing one or more chemicals through respective ports of an injector. In some of these embodiments, the chemicals are mixed with the water supply in a mixing chamber to obtain a chemical mixture. Some of these embodiments comprise introducing the chemical mixture to an irrigation system. In some of these embodiments, the irrigation system delivers the chemical mixture to a plurality of locations within the area of land. In some of these embodiments, chemical composition the chemical mixture is selected by the rate of flow of the water supply and is selected according to a treatment plan provided by a user. In some of these embodiments, the treatment plan is dynamically adjusted based on sensors that measure characteristics of the soil at the injection points. In some of these embodiments, controlling the rate of flow of the water supply includes pulsing a stream of water. Some of these embodiments comprise the step of controlling rates of flow of the one or more chemicals to the injector based on the injection plan.

Certain embodiments of the invention provide methods for treating soil. Some of these embodiments comprise pulsing a stream of pressurized water. Some of these embodiments comprise introducing a plurality of chemicals to the pulsed stream of water in a mixing chamber. In some of these embodiments, the mixing chamber turbulently mixes the chemicals with the pulsed water to obtain an injection mixture having a desired concentration of the plurality of chemicals. Some of these embodiments comprise providing the injection mixture to one or more injectors that introduce discrete predetermined amounts of the mixture to soil beneath the surface of the area of land at a plurality of injection points. In some of these embodiments, the chemical composition of the injection mixture introduced at each injection point is controlled based on the rate of flow of the water and is based on certain characteristics of the soil at the injection points. In some of these embodiments, the characteristics including one or more of moistness of the soil, density of the soil and a treatment plan provided by a user.

Certain embodiments of the invention employ systems and methods for injecting materials into soil within a predetermined geographical area. Some of these embodiments comprise at least one buffer configured to receive a measured amount of a material for injecting into the soil. Some of these embodiments comprise a propellant that pressurizes the measured amount of the material in the buffer. Some of these embodiments comprise a controller that measure the amount of material provided to the buffer and controls the pressurization of the material in the buffer. In some of these embodiments, the controller causes the measured amount of the material to be released within a certain time. In some of these embodiments, the controller calculates the amount of material. In some of these embodiments, the controller calculates the pressurization. In some of these embodiments, the controller calculates the certain time. In some of these embodiments, the calculations of the controller provide a desired concentration of the material in the soil.

In some of these embodiments, the certain time is controlled by the rate of release of material from the buffer. In some of these embodiments, the desired concentration varies across the geographic area. In some of these embodiments, the controller adjusts at least one of the amount, the pressurization and the certain time in accordance with the variation in desired concentration. In some of these embodiments, a soil characteristic varies across the geographic area. In some of these embodiments, the controller adjusts at least one of the amount, the pressurization and the certain time in accordance with the variation in desired concentration. In some of these embodiments, the soil characteristic comprises moistness of the soil. In some of these embodiments, the soil characteristic comprises density of the soil.

In some of these embodiments, the at least one buffer includes a plurality of buffers. Some of these embodiments comprise a mixer for mixing materials from the plurality of buffers according to a formula calculated by the controller. In some of these embodiments, each buffer receives a material that is different from the materials received by the other buffers in a quantity that is measured independently of the quantities of the other materials. In some of these embodiments, the propellant includes a component that promotes mixing of the different materials. In some of these embodiments, wherein the component is steam.

Certain embodiments of the invention provide systems for controlling the treatment of an area of soil. Some of these embodiments comprise one or more tanks that store chemicals for introducing into the soil. Some of these embodiments comprise an injector having a mixing chamber that mixes measured quantities of the chemicals and introduces the mixed chemicals to a stream of water to obtain a chemical mixture. Some of these embodiments comprise a controller that controls the stream of water. In some of these embodiments, the controller measures the quantities of chemicals. In some of these embodiments, the controller causes the injector to release discrete predetermined amounts of the chemical mixture into the soil at a sequence of injection points. In some of these embodiments, the controller provides a signal that pulses the stream of water, thereby controlling the volume and rate of delivery of water to the mixing chamber.

In some of these embodiments, frequency and duty cycle of the signal are selected to obtain a desired concentration of chemicals in the chemical mixture. In some of these embodiments, the frequency and the duty cycle of the signal are selected based on a measurement of the rate of flow of a chemical to the mixing chamber.

Some of these embodiments comprise a propellant that pressurizes the chemicals in the one or more tanks. In some of these embodiments, the chemicals comprise a plurality of chemicals. In some of these embodiments, rate of delivery of each chemical to the mixing chamber is independently controlled by the controller. In some of these embodiments, the certain time is controlled by the rate of release of material from the buffer. In some of these embodiments, certain of the injection points receive chemical mixtures having different concentrations of chemicals. In some of these embodiments, certain of the injection points receive different amounts of the chemical mixtures. In some of these embodiments, quantity and concentration of the chemical mixture is selected according to moistness of the soil at each injection point. In some of these embodiments, quantity and concentration of the chemical mixture is selected according to density of the soil at each injection point. In some of these embodiments, quantity and concentration of the chemical mixture at each injection point is selected based on a treatment plan provided by a user. In some of these embodiments, temperature of the chemical mixture at each injection point is selected based on a treatment plan provided by a user.

Certain embodiments of the invention provide methods for treating an area of soil. Some of these embodiments comprise mixing one or more chemicals in an injector. Some of these embodiments comprise providing the mixed chemicals in stream of water to obtain an injection mixture. In some of these embodiments, providing the mixed chemicals includes measuring rates of delivery of the one or more chemicals to the injector. In some of these embodiments, providing the mixed chemicals includes controlling rate of flow of the stream of water to obtain a desired concentration of chemicals in the injection mixture. Some of these embodiments comprise introducing discrete calculated amounts of the injection mixture into the soil at a plurality of injection points. In some of these embodiments, the volume chemical composition of each discrete predetermined amount of injection mixture is calculated by a controller configured to treat an area of land according to a treatment plan. In some of these embodiments, the treatment plan is dynamically adjusted based on sensors that measure characteristics of the soil at the injection points. In some of these embodiments, the treatment plan accounts for differences in the soil moistness across the area of land. In some of these embodiments, the treatment plan accounts for differences in the soil density across the area of land. In some of these embodiments, the treatment plan accounts for speed of a delivery vehicle.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A system, comprising:
one or more tanks that store chemicals for treating one or more of soil and crops planted in the soil;
an injector having a plurality of ports, each port receiving a flow comprising one of the chemicals, the injector having a mixing chamber that mixes the chemicals received at the ports with a medium, the injector providing a mixture of the chemicals in the medium; and
a controller configured to control the rate of flow of the medium, wherein
the rate of flow of the medium is selected to obtain a desired concentration of the chemicals in the mixture, and wherein
the mixture is provided to a delivery system that treats an area of land.

2. The system of claim 1, wherein the medium comprises a propellant and the mixture is provided to one or more injectors that introduce the mixture to soil beneath the surface of the area of land.

3. The system of claim 2, wherein the propellant comprises pressurized water.

4. The system of claim 2, wherein the mixture is introduced to the soil in predetermined amounts and at a plurality of injection points.

5. The system of claim 4, wherein some of the injection points receive chemical mixtures having different concentrations of the chemicals than other of the injection points.

6. The system of claim 5, wherein quantity and concentration of the chemical mixture is selected according to moistness of the soil at each injection point.

7. The system of claim 5, wherein quantity and concentration of the chemical mixture is selected according to density of the soil at each injection point.

8. The system of claim 5, wherein quantity and concentration of the chemical mixture at each injection point is selected based on a treatment plan provided by a user.

9. The system of claim 5, wherein temperature of the chemical mixture at each injection point is selected based on a treatment plan provided by a user.

10. The system of claim 1, wherein the medium comprises a stream of water and the mixture is provided to an irrigation line that irrigates the area of land.

11. The system of claim 10, wherein the controller provides a signal that pulses the stream of water to control the concentration of chemicals.

12. The system of claim 11, wherein frequency and duty cycle of the signal are selected to obtain a desired concentration of chemicals in the chemical mixture.

13. The system of claim 11, wherein the frequency and the duty cycle are selected based on the rate of flow of the chemicals to the mixing chamber.

14. The system of claim 11, wherein the rate of delivery of each chemical to the mixing chamber is independently controlled by the controller.

15. The system of claim 1, further comprising a plurality of buffers, each buffer controlling the flow of one of the plurality of chemicals responsive to the controller.

16. A method for treating an area of land using irrigation water, comprising:
controlling rate of flow of a water supply;
providing one or more chemicals through respective ports of an injector, wherein the chemicals are mixed with the water supply in a mixing chamber to obtain a chemical mixture;
introducing the chemical mixture to an irrigation system, wherein the irrigation system delivers the chemical mixture to a plurality of locations within the area of land,
wherein chemical composition the chemical mixture is selected by the rate of flow of the water supply and is selected according to a treatment plan provided by a user.

17. The method of claim 16, wherein the treatment plan is dynamically adjusted based on sensors that measure characteristics of the soil at the injection points.

18. The method of claim 16, wherein controlling the rate of flow of the water supply includes pulsing a stream of water;

19. The method of claim 16, and further comprising the step of controlling rates of flow of the one or more chemicals to the injector based on the injection plan.

20. A method for treating soil, comprising:
pulsing a stream of pressurized water;
introducing a plurality of chemicals to the pulsed stream of water in a mixing chamber, wherein the mixing chamber turbulently mixes the chemicals with the pulsed water to obtain an injection mixture having a desired concentration of the plurality of chemicals; and
providing the injection mixture to one or more injectors that introduce discrete predetermined amounts of the mixture to soil beneath the surface of the area of land at a plurality of injection points, wherein
the chemical composition of the injection mixture introduced at each injection point is controlled based on the rate of flow of the water and is based on certain characteristics of the soil at the injection points, the characteristics including one or more of moistness of the soil, density of the soil and a treatment plan provided by a user.
